(19) United States
(12) Patent Application Publication
(10) Pub. No.: US 2025/0315972 A1
(43) Pub. Date: Oct. 9, 2025

(54) ELECTRONIC DEVICE, METHOD, AND COMPUTER-READABLE STORAGE MEDIUM FOR IDENTIFYING LOCATION OF BODY PART FROM ONE OR MORE IMAGES

(71) Applicant: NCSOFT Corporation, Seoul (KR)

(72) Inventors: Sangjun Ahn, Seongnam-si (KR); Sunwon Jeong, Seongnam-si (KR); Sungbum Park, Seongnam-si (KR)

(73) Assignee: NCSOFT Corporation, Seoul (KR)

(21) Appl. No.: 19/241,809

(22) Filed: Jun. 18, 2025

Related U.S. Application Data
(63) Continuation of application No. PCT/KR2023/004291, filed on Mar. 30, 2023.

(51) Int. Cl. G06T 7/70; G06T 7/00; G06T 7/20; G06V 10/26; G06V 10/82; G06V 40/10

(52) U.S. Cl. CPC G06T 7/70; G06T 7/20; G06T 7/97; G06V 10/26; G06V 10/82; G06V 40/10; G06T 2200/04; G06T 2207/20084; G06T 2207/30196

(57) ABSTRACT

An electronic device includes memory storing instructions; and one or more processors, wherein the instructions, when executed by the one or more processors, cause the electronic device to input, into a neural network, at least one image, from among images that are obtained from different viewpoints, to obtain first information indicating locations of body parts of a subject included in the images, wherein the first information includes first location data indicating a first locations of portions of the body parts within a first image from among the images, and wherein the first locations are determined based on a first visibility values of the portions in the first image; obtain, based on the first information, second information indicating a second locations of the body parts at moments when the images were obtained; and track positions of the body parts in a virtual three-dimensional space based on the second information.

### CROSS-REFERENCE TO RELATED APPLICATIONS

This application is a by-pass continuation application of International Application No. PCT/KR2023/004291, filed on Mar. 30, 2023, the disclosure of which is incorporated herein by reference in its entirety.

### BACKGROUND

### 1. Field

The present disclosure relates to an electronic device, a method, and a computer-readable storage medium for identifying locations of body parts from one or more images.

### 2. Description of Related Art

Recently, there has been increasing interest in technology that identifies a location of a body part based on a three-dimensional coordinate system by photographing a body and interpreting the photographed image through a neural network. The neural network may mean a model that has an ability to solve a problem by adjusting an intensity of a coupling of a synapse through learning with respect to a node that forms a network through the coupling of the synapse. The neural network may be utilized for a purpose of identifying a plurality of images of a body obtained from different viewpoints.

### SUMMARY

According to an aspect of the disclosure, an electronic device includes memory storing instructions; and one or more processors, wherein the instructions, when executed by the one or more processors, cause the electronic device to input, into a neural network, at least one image, from among a plurality of images that are obtained from different viewpoints, to obtain first information indicating locations of a plurality of body parts of a subject included in the plurality of images, wherein the first information includes first location data indicating a first plurality of locations of a plurality of portions of the plurality of body parts within a first image from among the plurality of images, and wherein the first plurality of locations are determined based on a first plurality of visibility values of the plurality of portions in the first image; obtain, based on the first information, second information indicating a second plurality of locations of the plurality of body parts at moments when the plurality of images were obtained; and track positions of the plurality of body parts in a virtual three-dimensional space based on the second information.

The instructions, when executed by the one or more processors, may cause the electronic device to decrease a first value of the first location data based on a first visibility value of the first body part in the first image.

The instructions, when executed by the one or more processors, may cause the electronic device to obtain, from the plurality of images, third information indicating a plurality of probabilities corresponding to a third plurality of locations, and the plurality of probabilities may indicate probabilities as to whether one or more body parts, from among the plurality of body parts, are present at locations from among the third plurality of locations; determine, based on the third information, a second plurality of visibility values corresponding to the one or more body parts; set a plurality of weights corresponding to the third plurality of locations based on the second plurality of visibility values; and update the first location data based on the plurality of weights.

The instructions, when executed by the one or more processors, may cause the electronic device to decrease the first value based on identifying, in the first image, that the first body part is occluded by a second body part from among the plurality of body parts.

The instructions, when executed by the one or more processors, may cause the electronic device to decrease the first value based on a change to a first weight corresponding to a first location of the first body part that is occluded by the second body part.

The instructions, when executed by the one or more processors, may cause the electronic device to, identify the first body part is occluded by the second body part based on a second image from among the plurality of images.

The first information may be represented in a virtual two-dimensional space, the second information may be represented in the virtual three-dimensional space, and a posture of the plurality of body parts may be represented in the virtual three-dimensional space. The instructions, when executed by the one or more processors, may cause the electronic device to obtain the second information by backprojecting the first information from the virtual two-dimensional space into the virtual three-dimensional space.

The plurality of images are obtained from a plurality of external electronic devices directed toward the subject from different locations.

The instructions, when executed by the one or more processors, may cause the electronic device to obtain a plurality of weights corresponding to the plurality of body parts, via the neural network, based on a second plurality of visibility values.

According to an aspect of the disclosure, a method performed by an electronic device includes, inputting, into a neural network, at least one image, from among a plurality of images that are obtained from different viewpoints, to obtain first information indicating locations of a plurality of body parts included in the plurality of images, wherein the first information includes first location data indicating a first plurality of locations of a plurality of portions of the plurality of body parts within a first image from among the plurality of images, and wherein the first plurality of locations are determined based on a first plurality of visibility values of the plurality of portions in the first image; obtaining, based on the first information, second information indicating a second plurality of locations of the plurality of body parts at moments when the plurality of images were obtained; and tracking positions of the plurality of body parts in a virtual three-dimensional space based on the second information.

The method may further include decreasing a first value of the first location data based on a first visibility value of a first body part in the first image.

The obtaining the first information may include obtaining, from the plurality of images, third information indicating a plurality of probabilities corresponding to a third plurality of locations, and the plurality of probabilities may indicate probabilities as to whether one or more body parts, from among the plurality of body parts, are present at locations from among the third plurality of locations; determine, based on the third information, a second plurality of visibility values corresponding to the one or more body parts; setting a plurality of weights corresponding to the third plurality of locations based on the second plurality of visibility values; and update the first location data based on the plurality of weights.

The decreasing the first value may further include decreasing the first value based on identifying, in the first image, that the first body part occluded by a second body part from among the plurality of body parts.

The decreasing the first value may include decreasing the first value based on a change to a first weight corresponding to a first location of the first body part that is occluded by the second body part.

The decreasing the first value may include identifying that the first body part is occluded by the second body part based on a second image from among the plurality of images.

The first information may be represented in a virtual two-dimensional space, the second information may be represented in the virtual three-dimensional space, and a posture of the plurality of body parts may be represented in the virtual three-dimensional space. The obtaining the second information may include obtaining the second information by backprojecting the first information from the virtual two-dimensional space into the virtual three-dimensional space.

The plurality of images are obtained from a plurality of external electronic devices directed toward the subject from different locations.

The method may further include obtaining a plurality of weights corresponding to the plurality of body parts, via the neural network, based on a second plurality of visibility values.

According to an aspect of the disclosure, a non-transitory computer readable storage medium having instructions recorded thereon, that, when executed by one or more processors, cause the one or more processors to input into a neural network, at least one image from among a plurality of images that are obtained from different viewpoints, to obtain first information indicating locations of a plurality of body parts of a subject included in the plurality of images, wherein the first information includes first location data indicating a first plurality of locations of a plurality of portions of the plurality of body parts within a first image from among the plurality of images, and wherein the first plurality of locations are determined based on a first plurality of visibility values of the plurality of portions in the first image; and obtain, based on the first information, second information indicating a second plurality of locations of the plurality of body parts at moments when the plurality of images were obtained; and track positions of the plurality of body parts in a virtual three-dimensional space based on the second information.

The instructions, when executed by the one or more processors, may cause the one or more processors to decrease a first value of the first location data based on a first visibility value of the first body part in the first image.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 illustrates an exemplary state including an electronic device according to an embodiment.

FIG. 2 is an exemplary diagram for describing a neural network obtained by an electronic device from a set of parameters stored in memory, according to an embodiment.

FIG. 3 illustrates an exemplary state including an electronic device according to an embodiment.

FIG. 4 illustrates an exemplary state in which an electronic device identifies a location of each of body parts using an image indicating the body parts according to an embodiment.

FIG. 5 illustrates an example of an operation in which an electronic device obtains information for identifying locations of body parts using an image indicating the body parts according to an embodiment.

FIG. 6 illustrates an example of an operation in which an electronic device identifies locations of body parts based on a three-dimension from a plurality of images based on a two-dimension according to an embodiment.

FIG. 7 illustrates an example of an operation in which an electronic device identifies a location of a body part based on a three-dimension from an image according to an embodiment.

FIG. 8 illustrates an exemplary flowchart indicating an operation of an electronic device according to an embodiment.

FIG. 9 is a simplified block diagram illustrating a functional configuration of an electronic device according to an embodiment.

### DETAILED DESCRIPTION

The embodiments described in the disclosure, and the configurations shown in the drawings, are only examples of embodiments, and various modifications may be made without departing from the scope and spirit of the disclosure.

Various embodiments of the present document will be described with reference to the accompanying drawings.

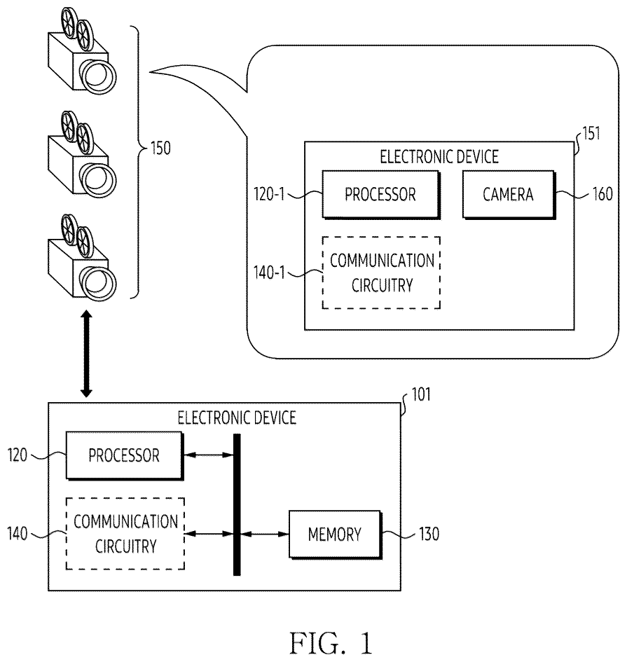

FIG. 1 illustrates an exemplary state including an electronic device according to an embodiment. Referring to FIG. 1, an exemplary situation in which an electronic device 101 and external electronic devices 150 are connected to each other based on a wired network and/or a wireless network is illustrated. The wired network may include a network such as the Internet, a local area network (LAN), a wide area network (WAN), or a combination thereof. The wireless network may include a network such as long term evolution (LTE), 5g new radio (NR), wireless fidelity (WiFi), Zigbee, near field communication (NFC), Bluetooth, Bluetooth low-energy (BLE), or a combination thereof. Although the electronic device 101 and the external electronic devices 150 are illustrated as being directly connected, the electronic device 101 and the external electronic devices 150 may be indirectly connected through one or more routers and/or an access points (AP).

Referring to FIG. 1, according to an embodiment, the electronic device 101 may include at least one of a processor 120, memory 130, or communication circuitry 140. The processor 120, the memory 130, and the communication circuitry 140 may be electronically and/or operably coupled with each other by an electronic component such as a communication bus. A type and/or the number of hardware components included in the electronic device 101 is not limited as illustrated in FIG. 1. For example, the electronic device 101 may include only some of hardware components illustrated in FIG. 1. As an example, the electronic device 101 may include another camera corresponding to a camera 160 included in an external electronic device 151.

The processor 120 of the electronic device 101 according to an embodiment may include a hardware component for processing data based on one or more instructions. The hardware component for processing data may include, for example, an arithmetic and logic unit (ALU), a field programmable gate array (FPGA), an application processor (AP), a communication processor (CP), a neural processor circuit (NPC), a graphics processing unit (GPU), and/or a central processing unit (CPU). The number of the processors 120 may be one or more. For example, the processor 120 may have a structure of a multi-core processor such as a dual core, a quad core, or a hexa core. The processor 120 may be an example of a system on chip (SoC) in that it includes a plurality of hardware components. For example, the processor 120 may further include system memory, flash memory, and/or a sensor.

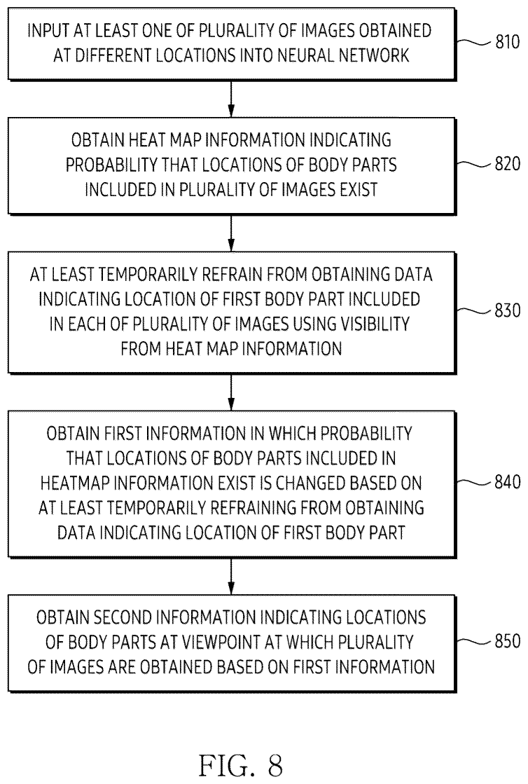

The memory 130 of the electronic device 101 according to an embodiment may include a hardware component for storing data and/or instructions input and/or output to the processor 120. The memory 130 may include, for example, volatile memory such as random-access memory (RAM) and/or non-volatile memory such as read-only memory (ROM). The volatile memory may include, for example, at least one of dynamic RAM (DRAM), static RAM (SRAM), cache RAM, and pseudo SRAM (PSRAM). The non-volatile memory may include, for example, at least one of programmable ROM (PROM), erasable PROM (EPROM), electrically erasable PROM (EEPROM), flash memory, a hard disk, a compact disk, and an embedded multimedia card (eMMC). In the memory 130 of the electronic device 101 according to an embodiment, one or more instructions indicating an operation to be performed by the processor 120 on data may be stored. A set of instructions may be referred to as firmware, an operating system, a process, a routine, a sub-routine, and/or an application. For example, the electronic device 101 and/or the processor 120 of the electronic device 101 may perform at least one of operations of FIG. 8 by executing a set of a plurality of instructions distributed in a form of an application. An application being installed in the electronic device 101 may mean that one or more instructions provided in the form of the application are stored in the memory 130, and one or more applications are stored in a format (e.g., a file with an extension preset by an operating system of the wearable device 101) executable by the processor 120. As an example, an application may include a program and/or a library related to a service provided to a user.

According to an embodiment, the memory 130 of the electronic device 101 may include a neural network that has been trained or will be trained using a set of one or more parameters stored in the memory 130. For example, the electronic device 101 may obtain a plurality of images from the external electronic devices 150. The plurality of images may correspond to body parts viewed based on different locations.

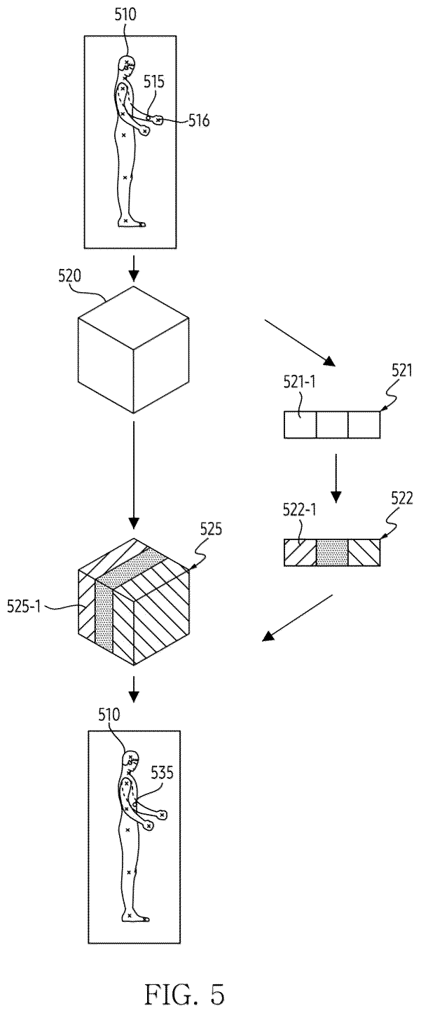

For example, the electronic device 101 may use the neural network to identify locations of the body parts included in the plurality of images. For example, the electronic device 101 may obtain data indicating the locations of the body parts using the neural network. The neural network may include an operation for obtaining weights respectively corresponding the body parts based on the visibility for each of the body parts. The operation may include at least one function and/or at least one layer used to calculate the weights to be obtained based on the number of the body parts included in the plurality of images. The electronic device 101 may train the neural network to obtain the weights corresponding to the body parts based on the visibility of the body parts included in each of the plurality of images, by inputting at least one of the plurality of images into the neural network. An operation in which the electronic device 101 obtains a weight using the neural network will be described later with reference to FIG. 5.

For example, the electronic device 101 may identify a first body part and a second body part occluded by the first body part among the body parts based on a first image among the plurality of images. The electronic device 101 may set a weight corresponding to the second body part relatively low. The electronic device 101 may at least temporarily refrain from obtaining data indicating a location of the second body part based on the relatively low set weight. The electronic device 101 may obtain data indicating the location of the second body part by using a second image including body parts viewed based on a location different from the first image. The electronic device 101 may identify whether to obtain data indicating the locations of the body parts based on whether each of the body parts overlaps, by using the plurality of images. An operation in which the electronic device 101 obtains a weight used to identify whether to obtain data indicating the locations of the body parts by inputting an image including the body parts into the neural network in the memory will be described later in FIG. 5.

The communication circuitry 140 of the electronic device 101 according to an embodiment may include hardware for supporting transmission and/or reception of an electrical signal between the electronic device 101 and the external electronic devices 150. Only the external electronic devices 150 are illustrated as other electronic devices connected through the communication circuitry 140 of the electronic device 101, but an embodiment is not limited thereto. For example, the electronic device 101 may establish a communication link with an external electronic device (e.g., a server) that is distinguished from the electronic device 101 using the communication circuitry 140. For example, the communication circuitry 140 may include at least one of a MODEM, an antenna, and an optical/electronic (O/E) converter. The communication circuitry 140 may support transmission and/or reception of an electrical signal based on various types of protocols such as Ethernet, local area network (LAN), wide area network (WAN), wireless fidelity (WiFi), Bluetooth, bluetooth low energy (BLE), ZigBee, long term evolution (LTE), and 5G new radio (NR).

For example, the electronic device 101 may receive signals indicating a plurality of images from the external electronic devices 150 connected using the communication circuitry 140. The electronic device 101 may obtain the plurality of images based on receiving the signals indicating the plurality of images. The external electronic devices 150 connected to the electronic device 101 may obtain a plurality of images indicating a shape of body parts viewed from different angles, by being positioned at different locations, respectively. The external electronic devices 150 may transmit a signal indicating the plurality of images indicating the shape of the body parts viewed from the different angles to the electronic device 101 using communication circuitry (e.g., communication circuitry 140-1).

Referring to FIG. 1, the external electronic devices 150 according to an embodiment may be located outside the electronic device 101. The external electronic devices 150 according to an embodiment may include at least one of a processor (e.g., a processor 120-1), communication circuitry (e.g., the communication circuitry 140-1), or a camera (e.g., the camera 160). The processor, the communication circuitry, and the camera may be electronically and/or operably coupled with each other by an electronical component such as a communication bus. Referring to FIG. 1, only a hardware configuration of one external electronic device among the external electronic devices 150 is illustrated, but is not limited thereto. A type and/or the number of hardware components included in the external electronic devices 150 is not limited as illustrated in FIG. 1. For example, the external electronic devices 150 may include only some of hardware components illustrated in FIG. 1.

According to an embodiment, the camera 160 of an external electronic device 151, which is one of the external electronic devices 150 may include one or more optical sensors (e.g., a charged coupled device (CCD) sensor and a complementary metal oxide semiconductor (CMOS) sensor) that generate an electrical signal indicating a color and/or brightness of light. A plurality of optical sensors in the camera 160 may be positioned in a form of a 2 dimensional array. The camera 160 may generate an image corresponding to light reaching the optical sensors of the 2 dimensional array and including a plurality of pixels arranged in a two-dimension, by substantially simultaneously obtaining an electrical signal of each of the plurality of optical sensors. For example, photo data captured using the camera 160 may mean an image obtained from the camera 160. For example, video data captured using the camera 160 may mean a sequence of a plurality of images obtained from the camera 160 according to a preset frame rate.

The external electronic devices 150 positioned at different locations according to an embodiment may obtain a plurality of images including a shape of a body based on different angles using a camera (e.g., the camera 160). The external electronic devices 150 may transmit the plurality of images to the electronic device 101 using communication circuitry (e.g., the communication circuitry 140-1). It is not limited thereto. The external electronic devices 150 may transmit the plurality of images to the electronic device 101 by using an interface for transmitting at least one information to a device. The electronic device 101 may correspond to a central management server in terms of receiving information indicating a plurality of images from each of the external electronic devices 150.

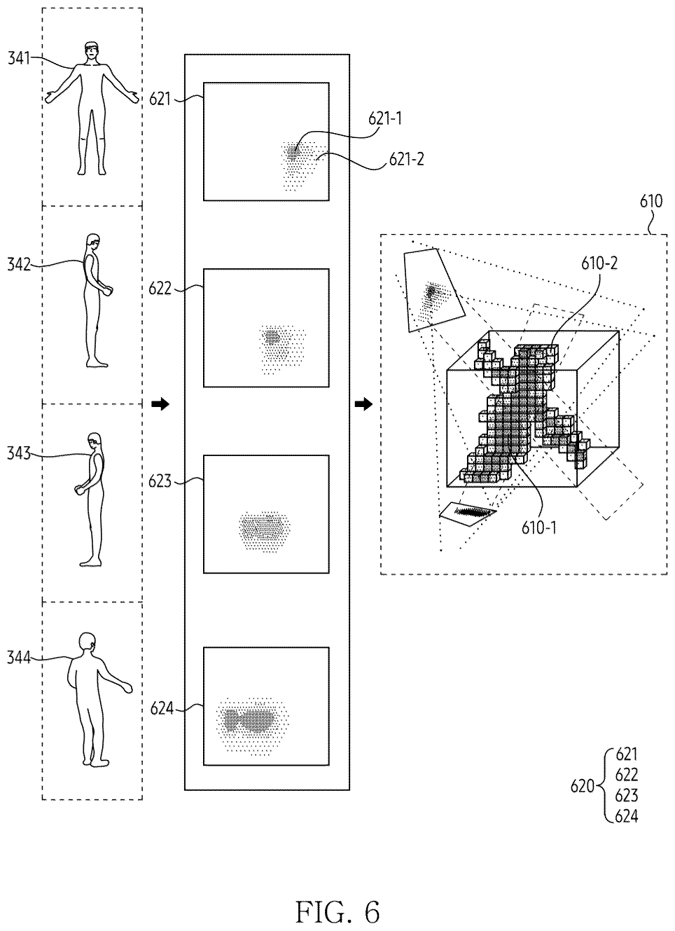

For example, the electronic device 101 may obtain a plurality of images in which body parts are captured from the external electronic devices 150. The electronic device 101 may obtain heat map information indicating a probability that body parts exist using the plurality of images. The electronic device 101 may change the probability of the existence of body parts in the heat map information by using the neural network stored in the memory 130. The electronic device 101 may obtain or may not obtain data indicating locations of body parts based on visibility values of each of the body parts to change the probability that the body parts exist in the plurality of images. The electronic device 101 may obtain information indicating locations of body parts based on a three-dimension using information indicating locations of body parts based on the changed probability. A backprojecting operation in which the electronic device 101 in a virtual three-dimensional space to obtain the information indicating the locations of the body parts based on three-dimension will be described later in FIG. 6.

The electronic device 101 according to an embodiment may change a probability indicating a location of each of body parts by using visibility of each of the body parts included in the first image among the plurality of images to tune the heat map information. The electronic device 101 may adjust weights respectively corresponding to each of the body parts to identify the locations of the body parts based on the visibility of each of the body parts. The electronic device 101 may obtain the weights corresponding to each of the body parts included in the first image by using the neural network stored in the memory 130. The electronic device 101 may identify whether to obtain information indicating the locations of the body parts from the first image by using the weight. The electronic device 101 may relatively improve accuracy of the locations of the body parts than a case of identifying whether to use at least one image among a plurality of images, by identifying whether to obtain data for each of the body parts based on the visibility of each of the body parts.

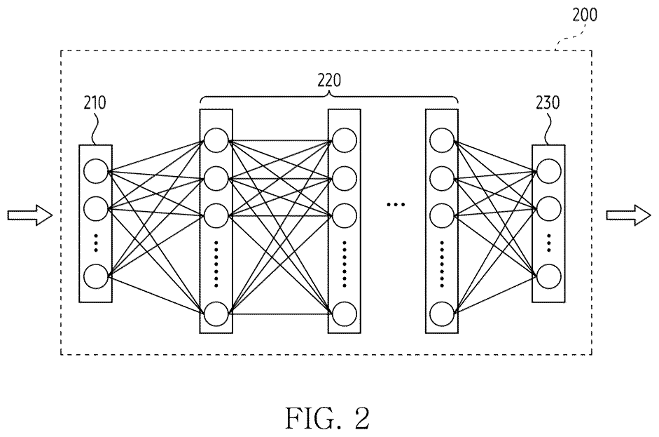

FIG. 2 is an exemplary diagram for describing a neural network obtained by an electronic device from a set of parameters stored in memory, according to an embodiment. Referring to FIG. 2, a set of parameters related to a neural network 200 may be stored in memory (e.g., the memory 130 of FIG. 1) of an electronic device (e.g., the electronic device 101 of FIG. 1) according to an embodiment. The neural network 200 is a recognition model implemented as software or hardware that mimics a computational ability of a biological system by using a large number of artificial neurons (or nodes). The neural network 200 may perform a human cognitive function or a learning process through the artificial neurons. The parameters related to the neural network 200 may indicate, for example, a plurality of nodes included in the neural network 200 and/or a weight assigned to a connection between the plurality of nodes. The number of neural networks 200 stored in memory 104 is not limited as illustrated in FIG. 2, and sets of parameters corresponding to each of the plurality of neural networks may be stored in the memory 104.

A model trained by the electronic device 101 according to an embodiment may be implemented based on the neural network 200 indicated based on a set of a plurality of parameters stored in the memory 130. Neurons of the neural network 200 corresponding to the model may be distinguished along a plurality of layers. The neurons may be indicated as a connection line connecting a node included in a layer and another node included in another layer different from the layer, and/or as a weight assigned to the connection line. For example, the neural network 200 may include an input layer 210, hidden layers 220, and an output layer 230. The number of the hidden layers 220 may be different according to an embodiment.

The input layer 210 may receive a vector (e.g., a vector having elements corresponding to the number of nodes included in the input layer 210) indicating input data. Based on the input data, signals generated from each of nodes in the input layer 210 may be transmitted from the input layer 210 to the hidden layers 220. The output layer 230 may generate output data of the neural network 200 based on one or more signals received from the hidden layers 220. The output data may include, for example, a vector having elements mapped to each of nodes included in the output layer 230.

The hidden layers 220 may be located between the input layer 210 and the output layer 230 and may change the input data transmitted through the input layer 210. For example, as the input data received through the input layer 210 is propagated sequentially along the hidden layers 220 from the input layer 210, the input data may be gradually changed based on a weight connecting nodes of different layers.

Each of the layers (e.g., the input layer 210, the hidden layers 220, and the output layer 230) included in the neural network 200 may include a plurality of nodes. The hidden layers 220 may be convolution filters or fully connected layers in a convolutional neural network (CNN), or various types of filters or layers grouped based on a function or characteristic.

A structure in which nodes are connected between different layers is not limited to an example of FIG. 2. In an embodiment, one or more hidden layers 220 may be a layer based on a recurrent neural network (RNN) in which an output value is input back to a hidden layer of the current time. In an embodiment, based on Long Short-Term Memory (LSTM), the neural network 200 may further include one or more gates (and/or filters) for discarding at least one of values of the nodes, maintaining it for a relatively long period of time, or maintaining it for a relatively short period of time. The neural network 200 according to an embodiment may form a deep neural network by including numerous hidden layers 220. Training a deep neural network is called deep learning. A node included in the hidden layers 220 may be referred to as a hidden node.

Nodes included in the input layer 210 and the hidden layers 220 may be connected to each other through a connection line having a weight, and nodes included in the hidden layers 220 and the output layer 230 may also be connected to each other through a connection line having a weight. Tuning and/or training the neural network 200 may mean changing weights between the nodes included in each of the layers (e.g., the input layer 210, the hidden layers 220, and/or the output layer 230) included in the neural network 200. Tuning the neural network 200 may be performed based on, for example, supervised learning and/or unsupervised learning.

The electronic device 101 according to an embodiment may train a model 240 based on the supervised learning. The supervised learning may mean training the neural network 200 using a set of paired input data and output data. For example, the neural network 200 may be tuned to reduce a difference between output data output from the output layer 230 and output data included in the set in a state of receiving the input data included in the set. As the number of sets increases, the neural network 200 may generate output data generalized by one or more sets with respect to other input data different from the set.

The electronic device 101 according to an embodiment may tune the neural network 200 based on reinforcement learning in the unsupervised learning. For example, the electronic device 101 may change policy information used by the neural network 200 to control an agent based on interaction between the agent and an environment. The electronic device 101 according to an embodiment may cause a change in the policy information by the neural network 200 in order to maximize a goal and/or a reward of the agent by the interaction. The neural network 200 may be trained to obtain an output value based on identifying an input value. An operation in which the electronic device 101 obtains information indicating locations of body parts from a plurality of images using the neural network 200 will be described later.

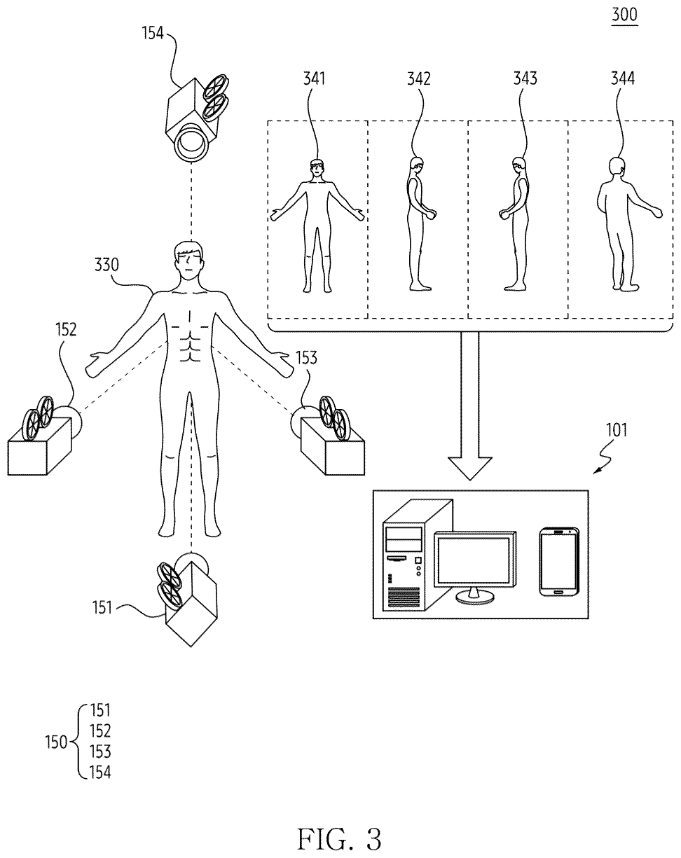

FIG. 3 illustrates an exemplary state including an electronic device according to an embodiment. Referring to FIG. 3, an exemplary state 300 including an electronic device 101 and/or external electronic devices 150 is illustrated. The electronic device 101 of FIG. 3 may be an example of the electronic device 101 of FIGS. 1 to 2. The external electronic devices 150 may be used to capture at least a part of a body 330. The external electronic devices 150 may capture different body parts of the body 330 by directing the body 330 from different angles. The external electronic devices 150 directing the body 330 from different angles may include a camera (e.g., a camera 160) included in each of the external electronic devices 150 directing the body 330. The external electronic devices 150 may capture different body parts of the body 330 based on different viewpoints. A viewpoint may mean a range that the camera may capture at a timing. For example, a timing may include a timepoint at which each of a plurality of images is captured. The external electronic devices 150 may obtain a plurality of images indicating the body 330 based on the same posture based on the timing.

For example, the external electronic devices 150 may obtain an image based on receiving light from the outside. A first external electronic device 151 may capture at least a part of the body 330 based on receiving light from the body 330. For example, the first external electronic device 151 may direct a front surface of the body 330. The first external electronic device 151 may obtain a first image 341 corresponding to the front surface of the body 330 by directing the front surface of the body 330.

For example, a second external electronic device 152 may capture a left side surface of the body 330 by directing the left side surface of the body 330. For example, a third external electronic device 153 may capture a right side surface of the body 330 by directing the right side surface of the body 330. For example, a fourth external electronic device 154 may capture a rear surface of the body 330 by directing a rear surface of the body 330. It is not limited thereto, and a disposition relationship of the external electronic devices 150 may be variously changed. FIG. 3 illustrates that the number of the external electronic devices 150 is four, but this is for convenience of explanation. The number of the external electronic devices 150 for capturing the body 330 is not limited by those illustrated in FIG. 3. As an example, in a case that the electronic device 101 includes a camera for capturing the body 330, the electronic device 101 may capture a part of the body 330 using the camera by directing the part of the body 330.

For example, as the body 330 is captured at different viewpoints, a plurality of images 341, 342, 343, and 344 may be obtained by the external electronic devices 150. The plurality of images 341, 342, 343, and 344 may be obtained from the external electronic devices 150 directed toward the body 330 at different locations, respectively. For example, the first image 341 may correspond to an image for the front surface of the body 330 by being obtained by the first external electronic device 151. The second image 342 may correspond to the left side surface of the body 330 by being obtained by the second external electronic device 152. The third image 343 may be referred to the right side surface of the body 330 by being obtained by the third external electronic device 153. The fourth image 344 may include an image for the rear surface of the body 330 by being obtained by the fourth external electronic device 154.

According to an embodiment, the plurality of images 341, 342, 343, and 344 may be obtained by capturing a posture (or a shape) of the body 330 at the same timing from different angles.

For example, the external electronic devices 150 may capture the body 330 maintained in a shape using the camera. For example, the external electronic devices 150 may obtain the plurality of images 341, 342, 343, and 344 corresponding to the body 330 while the shape of the body 330 is maintained based on receiving light from the body 330 using the camera (or an image sensor).

For example, each of the external electronic devices 150 may move while a shape of the body 330 is maintained. For example, the movement of the external electronic devices 150 may include a change in an angle at which each of the external electronic devices 150 directs the body 330 while maintaining a state in which each of the external electronic devices 150 directs the body 330. For example, the movement of the external electronic devices 150 may include a change in a distance between the external electronic devices 150 and the body 330 while maintaining the state in which each of the external electronic devices 150 directs the body 330. It is not limited thereto.

For example, the plurality of images 341, 342, 343, and 344 obtained by the external electronic devices 150 may be images in which the shape (or the posture) of the body 330 is captured based on different timings. The plurality of images 341, 342, 343, and 344 may be images in which the body 330, whose shape changes based on different timings, is captured from different angles by the external electronic devices 150.

For example, the electronic device 101 may obtain the plurality of images 341, 342, 343, and 344 from the external electronic devices 150 based on a communication link connected to the external electronic devices 150. The electronic device 101 may identify a body and/or body parts corresponding to each of the plurality of images 341, 342, 343, and 344 based on obtaining the plurality of images 341, 342, 343, and 344. The body parts may mean joints included in the body 330, but are not limited thereto. For example, the electronic device 101 may identify a probability indicating locations of the body parts of the body 330 corresponding to each of the plurality of images 341, 342, 343, and 344, by using the plurality of images 341, 342, 343, and 344. The electronic device 101 may change the identified probability indicating the locations of the body parts by using weights corresponding to the locations of the body parts. The electronic device 101 may identify visibility with respect to the body parts by using each of the plurality of images 341, 342, 343, and 344. The electronic device 101 may set weights for the body parts based on the visibility values. For example, the weights for the body parts set by the electronic device 101 may be different for each of the plurality of images 341, 342, 343, and 344.

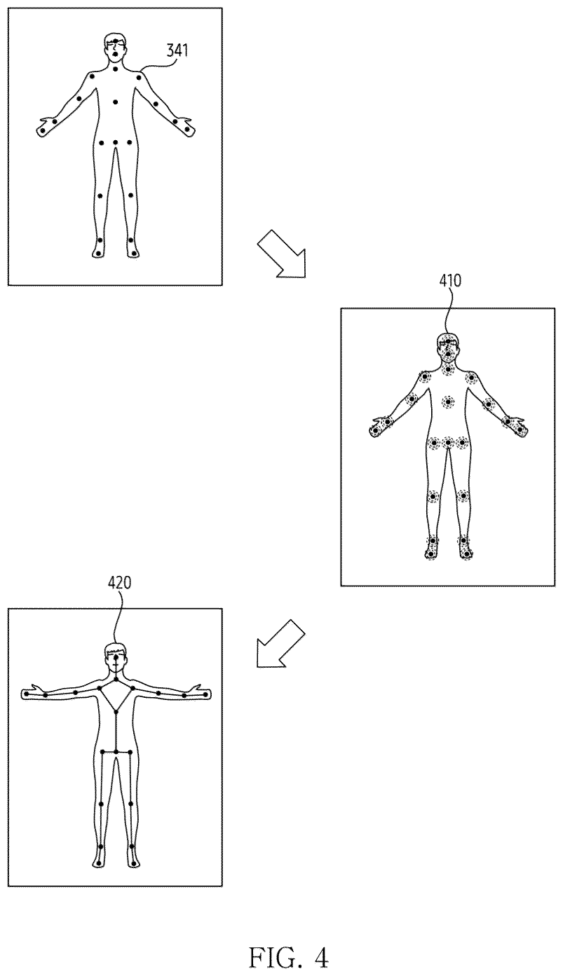

For example, in a case that a first body part may not be identified using one image (e.g., the image 342) among the plurality of images 341, 342, 343, and 344, the electronic device 101 may identify a location of the first body part using another image (e.g., the image 341). The electronic device 101 may set a weight corresponding to the location of the first body part included in the one image to be relatively lower than a weight corresponding to the location of the first body part included in the other image, based on failure to identify the first body part using the one image (e.g., the image 342). It is not limited thereto. An operation in which the electronic device 101 identifies a probability indicating locations of body parts will be described later with reference to FIG. 4. It will be described that the electronic device 101 operates based on receiving four images, but an operation of the electronic device 101 (or a processor 120) according to an embodiment is not limited thereto.

The electronic device 101 according to an embodiment may identify the locations of the body parts included in the body 330 based on an angle corresponding to each of the plurality of images 341, 342, 343, and 344 based on obtaining the plurality of images 341, 342, 343, and 344 from the external electronic devices 150 positioned at different locations. For example, in a case that one body part among the body parts included in the body 300 may not be identified using one image (e.g., the third image 343) among the plurality of images 341, 342, 343, and 344, the electronic device 101 identify the one body part using another image (e.g., the third image 343). The electronic device 101 may increase accuracy for identifying the locations of the body parts based on obtaining the plurality of images 341, 342, 343, and 344 from the external electronic devices 150.

FIG. 4 illustrates an exemplary state in which an electronic device identifies a location of each of body parts using an image indicating the body parts according to an embodiment. An electronic device 101 of FIG. 4 may include the electronic device 101 of FIGS. 1 to 3.

Referring to FIG. 4, by inputting at least one (e.g., the first image 341) of a plurality of images (e.g., the plurality of images 341, 342, 343, and 344 of FIG. 3) obtained from external electronic devices (e.g., the external electronic devices 150 of FIG. 1) into a neural network stored in memory (e.g., the memory 130 of FIG. 1), the electronic device 101 according to an embodiment may obtain heat map information 410 indicating a probability that each of body parts corresponding to the at least one exists. Referring to FIG. 4, the heat map information 410 on all body parts included in a body 330 is illustrated, but is not limited thereto, and the heat map information 410 may include a probability distribution for one body part among the body parts.

For example, the electronic device 101 may obtain the heat map information 410 using a keypoint corresponding to each of the body parts. The heat map information 410 may mean a probability that a body part in a body (e.g., the body 330 of FIG. 3) based on a two-dimension corresponding to the at least one exists. The heat map information 410 may include probability distributions indicating a probability that each of joints of the user exists in a virtual two-dimensional space. The heat map information 410 may include information on a probability distribution indicating a probability that a wrist joint, a right shoulder joint of the body, a left shoulder joint of the body, and/or a hip joint exists, and the like. The heat map information 410 may include dots indicating the probability that each of the body parts exists. For example, the electronic device 101 may identify a probability indicating locations of the body parts based on density of dots included in the heat map information 410. For example, the electronic device 101 may identify a location of one body part by using an area 410-1 including dots corresponding to the one body part (e.g., the left shoulder joint). The electronic device 101 may identify a location corresponding to dots of relatively high density among the area 410-1 as a location of one body part. As an example, the electronic device 101 may identify a location of one body part based on a dot indicating the highest probability among the area 410-1. The electronic device 101 may obtain location information 420 indicating a location of each of the body parts based on density of dots corresponding to each of the body parts.

For example, the electronic device 101 may obtain the heat map information 410 corresponding to each of a plurality of images 341, 342, 343, and 344. The electronic device 101 may change the heat map information 410 corresponding to each of the plurality of images based on the neural network. For example, the electronic device 101 may set weights corresponding to body parts based on visibility values of the body parts included in each of the plurality of images 341, 342, 343, and 344. The electronic device 101 may change density of dots indicating locations of the body parts included in the heat map information 410 by using the set weight. The electronic device 101 may change the heat map information 410 by using a weight corresponding to each of the body parts. Based on changing the heat map information corresponding to each of the body parts, the electronic device 101 may obtain the location information 420 indicating locations of the body parts in the image 341 by backprojecting the changed heat map information. An operation in which the electronic device 101 obtains the location information 420 based on a three-dimension by backprojecting the changed heat map information will be described later in FIG. 6.

The electronic device 101 according to an embodiment may obtain the heat map information 410 indicating locations of body parts corresponding to a front surface of a body (e.g., the body 330 of FIG. 3) included in the image 341 using the image 341. For example, the electronic device 101 may change the heat map information 410 based on the neural network. In order to change the heat map information 410, the electronic device 101 may check whether to identify each of the body parts. For example, in a case that a first body part among the body parts is covered by a second body part in the image 341, the electronic device 101 may refrain from obtaining heat map information on the first body part from the first image 341 by setting a weight corresponding to the first body part low. The electronic device 101 may obtain the heat map information on the first body part using the other images 342, 343, and 344. By refraining from obtaining the heat map information on the first body part, the electronic device 101 may reduce a data loss rate compared to a case of refraining from obtaining the entire heat map information 410 corresponding to the first image 341.

FIG. 5 illustrates an example of an operation in which an electronic device obtains information for identifying locations of body parts using an image indicating the body parts according to an embodiment. An electronic device 101 of FIG. 5 may include the electronic device 101 of FIGS. 1 to 4.

Referring to FIG. 5, the electronic device 101 according to an embodiment may obtain feature information 520 corresponding to one image (e.g., a third image 343) among a plurality of images 341, 342, 343, and 344 obtained from external electronic devices (e.g., the external electronic devices 150 of FIG. 1). The feature information 520 may be obtained based on the number of body parts included in heat map information 510 corresponding to the one image (e.g., the third image 343) and/or a size of the one image. The electronic device 101 may obtain the feature information 520 by inputting the one image to a neural network. The electronic device 101 may obtain a weight corresponding to each of the body parts based on obtaining the feature information 520.

For example, the electronic device 101 may identify whether to obtain data indicating a location of a body part based on the weight obtained from the feature information 520. The electronic device 101 may change a probability corresponding to the location of the body part based on the weight corresponding to the body part. The electronic device 101 may temporarily refrain from obtaining data on a location of a body part corresponding to a probability less than a preset threshold from the feature information 520 based on identifying the probability less than the preset threshold. The electronic device 101 temporarily refraining from obtaining the location data of the body part may include an operation of reducing a value of the location data of the body part by using the weight.

For example, the electronic device 101 may obtain data information 521 on locations of body parts using the feature information 520. The data information 521 may include information on a location of each of body parts. A size of the data information 521 may be adjusted based on the number of body parts. The electronic device 101 may obtain a weight for a body part based on whether the body part may be identified using the image (e.g., the third image 343) corresponding to the heat map information 510.

For example, the electronic device 101 may identify a location 515 of one body part (e.g., elbow) in the heat map information 510 corresponding to the image (e.g., the third image 343). The electronic device 101 may identify the location 515 of the one body part based on density of dots corresponding to the one body part. In the heat map information 510, the location 515 of the one body part may be positioned adjacent to a location 516 of another body part (e.g., hand). For example, in the image (e.g., the image 343), the one body part may overlap with still another body part (e.g., an upper body). The electronic device 101 may identify the location 515 for the one body part covered by the still other body part adjacent to the location 516 of the other body part. The electronic device 101 may correct the location 515 of the one body part using the neural network. For example, the electronic device 101 may obtain weight information 522 from the feature information 520 by using the neural network including one or more layers to obtain the weight information 522 corresponding to the feature information 520. For example, the electronic device 101 may obtain the weight information 522 by using the neural network including an operation to obtain the weight information 522 from the feature information 520. The operation may include at least one function and/or one or more layers for identifying the weight information 522 to be obtained based on the number of each of body parts from the feature information 520. It is not limited thereto.

For example, the electronic device 101 may change data 521-1 corresponding to a location of the one body part included in the data information 521 corresponding to the feature information 520. The electronic device 101 may adjust the data 521-1 based on identifying the one body part covered by still another body part. The electronic device 101 may set a weight corresponding to each of body parts from the image (e.g., the third image 343) corresponding to the heat map information 510, by using visibility for each of the body parts.

For example, the electronic device 101 may identify the weight information 522 obtained based on visibility values using the data information 521. The electronic device 101 may identify a weight 522-1 for the one body part by using visibility for the one body part. The electronic device 101 may set (or change) the weight 522-1 for the one body part relatively low by identifying the one body part occluded by still another body part (e.g., the upper body) in the image (e.g., the third image 343). The electronic device 101 may obtain the weight information 522 by using each of weights corresponding to each of the locations of the body parts included in the heat map information 510. The electronic device 101 may change the feature information 520 by using the obtained weight information 522. The electronic device 101 may obtain feature information 525 in which a probability indicated from the feature information 520 is changed by using the weight information 522. The electronic device 101 may obtain the feature information 525 by changing a probability distribution indicating the location of each of the body parts included in the feature information 520 using the weight information 522. The electronic device 101 may reduce a value of data indicating a location of each of body parts based on visibility values by using a weight.

For example, the electronic device 101 may at least temporarily refrain from obtaining data indicating the location 515 of the one body part in which the weight 522-1 is set relatively low by using the feature information 525. The electronic device 101 may identify data 525-1 indicating a location of one body part less than or equal to a preset threshold by using the feature information 525. The electronic device 101 may temporarily refrain from using the data indicating the location of the one body part included in the image (e.g., the third image 343) based on identifying the data 525-1 less than or equal to the preset threshold. For example, based on identifying a second body part occluded by a first body part, the electronic device 101 may reduce a value of data indicating a location of the first body part by using a weight corresponding to the location of the occluded first body part. The electronic device 101 may obtain the feature information 525 based on the reduced value of the data indicating the location of the first body part.

For example, based on temporarily refraining from obtaining data indicating the location of the one body part included in the image (e.g., the third image 343), the electronic device 101 may compensate for an absence of the data indicating the location of the one body part included in the image using other data (e.g., data obtained from the first image 341, the second image 342, or the fourth image 344).

For example, the electronic device 101 may identify a relationship for each of locations of body parts by inputting an image (e.g., the third image 343) into the neural network based on a self-attention structure. The electronic device 101 may use locations of other body parts among body parts to identify a location of one body part among the body parts based on the identified relationship. The electronic device 101 may infer the location of the one body part based on the locations of the other body parts. For example, the electronic device 101 may use the location of the one body part obtained from another image (e.g., the first image 341, the second image 342, or the fourth image 344) to infer the location of the one body part from the image (e.g., the third image 343). The electronic device 101 may train the neural network to set a weight corresponding to a location of each of body parts based on a self-attention method. It is not limited thereto. As an example, the electronic device 101 may identify a pose of a body (e.g., the body 330 of FIG. 3) using an angle of each of body parts included in a plurality of images input to the neural network.

For example, the electronic device 101 may obtain location data of one body part (e.g., elbow) using an image (e.g., the third image 343) and another image (e.g., the first image 341, the second image 342, or the fourth image 344) among a plurality of images obtained from the external electronic devices. Location data of the one body part obtained from the other image may have a data value based on relatively higher reliability than location data of the one body part obtained from the image (e.g., the third image 343). By using the location data of the one body part obtained from the other image, the electronic device 101 may more accurately identify the location of the one body part than using the data obtained from the image (e.g., the image 343).

For example, the electronic device 101 may obtain location information 530 indicating locations of body parts included in a body (e.g., the body 330) using feature information (e.g., the feature information 525) obtained from each of the plurality of images 341, 342, 343, and 344. A location 535 of one body part included in the location information 530 may be different from the location 515 of one body part included in the heat map information 510. For example, the location 535 of the one body part included in the location information 530 may be obtained from other heat map information corresponding to another image (e.g., the first image 341, the second image 342, or the fourth image 344) different from the heat map information 510. Referring to FIG. 5, it is illustrated that the location information 510 is obtained from the feature information 525 corresponding to one image, but location information based on a three-dimension may be obtained using feature information corresponding to a plurality of images. In FIG. 6, an operation for obtaining the location information based on the three-dimension using the feature information corresponding to the plurality of images will be described later.

The electronic device 101 according to an embodiment may change data indicating a location of each of body parts included in one image by using heat map information corresponding to the one image (e.g., the third image 343). In order to change the data indicating the location, the electronic device 101 may adjust a weight corresponding to the location. The electronic device 101 may change the weight based on visibility values of each of the body parts. The electronic device 101 may identify whether to use the data indicating the location of each of the body parts obtained from the one image by using the changed weight based on the visibility values. For example, in a case that data indicating a location of one body part obtained from the one image is not used, the electronic device 101 may identify the location of the one body part based on data obtained from the one image and another image. The electronic device 101 may more accurately identify a shape (or a posture) of the body (e.g., the body 330 of FIG. 3) by identifying the location of each of the body parts using the plurality of images 341, 342, 343, and 344.

FIG. 6 illustrates an example of an operation in which an electronic device identifies locations of body parts based on a three-dimension from a plurality of images based on a two-dimension according to an embodiment. Referring to FIG. 6, an electronic device 101 of FIG. 6 may include the electronic device 101 of FIGS. 1 to 5.

Referring to FIG. 6, the electronic device 101 according to an embodiment may obtain feature information 610 based on a three-dimension based on obtaining a plurality of images 341, 342, 343, and 344 from external electronic devices (e.g., the external electronic devices 150 of FIG. 1). The electronic device 101 may obtain the feature information 610 indicating a probability that a body part in a body (e.g., the body 330 of FIG. 3) exists, from the plurality of images 341, 342, 343, and 344. For example, the electronic device 101 may obtain the feature information 610 based on the three-dimension indicating a probability that each of the body parts of the body 330 exists based on identifying feature points of each of the plurality of images 341, 342, 343, and 344. The feature information 610 may indicate a probability that a body part exists in a virtual three-dimensional space. The feature information 610 may indicate the probability that the body part (e.g., a joint) exists in the virtual three-dimensional space in a form of a heat map. For example, an area 610-1 in which a probability that a body part exists is relatively high may include dots of relatively high density, and an area 610-2 in which the probability that a body part exists is relatively low may include dots of relatively low density. For example, a color of the area 610-1 in which the probability that the body part exists is relatively high may be different from a color of the area 610-2 in which the probability that the body part exists is relatively low. For example, the electronic device 101 may obtain the location information 510 of FIG. 5 indicating the location of the body parts in the body 330 using the feature information 610.

For example, the electronic device 101 may obtain feature information 620 based on a two-dimension indicating a probability that a body part exists from each of the plurality of images 341, 342, 343, and 344. The feature information 620 based on the two-dimension may indicate a probability that a body part exists in a virtual two-dimensional space. The feature information 620 based on the two-dimension may include probability distributions indicating a probability that each of joints of the body (e.g., the body 330 of FIG. 3) exists in the virtual two-dimensional space.

For example, the feature information 620 based on the two-dimension may indicate the probability that the body part exists in the virtual two-dimensional space in the form of the heat map. For example, an area 621-1 in which a probability that a body part exists is relatively high may include dots of relatively high density. An area 621-2 in which the probability that a body part exists is relatively low may include dots of relatively low density. A color of the area 621-1 in which the probability that the body part exists is relatively high and a color of the area 621-2 in which the probability that the body part exists is relatively low may be different from each other. The feature information 620 based on the two-dimension may include a probability distribution corresponding to substantially the same body part obtained from each of the plurality of images 341, 342, 343, and 344. It is not limited thereto. The feature information 620 based on the two-dimension may include a probability distribution corresponding to all body parts obtained from each of the plurality of images 341, 342, 343, and 344.

For example, the electronic device 101 may obtain the feature information 620 based on inputting each of the plurality of images 341, 342, 343, and 344 into a backbone network included in a neural network. The electronic device 101 may obtain the feature information 620 corresponding to each of the plurality of images 341, 342, 343, and 344 based on obtaining the plurality of images 341, 342, 343, and 344. According to an embodiment, the electronic device 101 may obtain the feature information 620 from each of the plurality of images 341, 342, 343, and 344 through the backbone network. For example, the electronic device may extract a class (or a type) of at least one object (e.g., body part) captured in a plurality of images and/or location information of the object, by using the neural network.

For example, the electronic device 101 may obtain first feature information 621 corresponding to the first image 341 based on obtaining the first image 341. The electronic device 101 may obtain second feature information 622 corresponding to the second image 342 based on obtaining the second image 342. The electronic device 101 may obtain third feature information 623 corresponding to the third image 343 based on obtaining the third image 343. The electronic device 101 may obtain fourth feature information 624 corresponding to the fourth image 344 based on obtaining the fourth image 344. An operation in which the electronic device 101 obtains the feature information 620 based on obtaining the plurality of images 341, 342, 343, and 344 may include an operation in which the electronic device 101 obtains the feature information 525 of FIG. 5 in which a probability that each of body parts exists is changed using the neural network by inputting each of the plurality of images 341, 342, 343, and 344 into the neural network. The feature information 620 may be referenced by the feature information 525 obtained by the electronic device 101 based on visibility values for body parts identified from each of the plurality of images 341, 342, 343, and 344.

According to an embodiment, the electronic device 101 may obtain the feature information 610 based on obtaining the feature information 620. The electronic device 101 may be configured to obtain the feature information 610 by backprojecting the feature information 620 into the virtual three-dimensional space. For example, the electronic device 101 may obtain the feature information 610 from the feature information 620 based on inputting the feature information 620 into an algorithm for backprojecting it into the virtual three-dimensional space. It is not limited thereto. As an example, the electronic device 101 may obtain the feature information 610 from the feature information 620 based on inputting the feature information 620 into a pre-trained neural network.

For example, the feature information 610 may indicate a probability that a body part captured in the plurality of images 341, 342, 343, and 344 exists in the virtual three-dimensional space. For example, the electronic device 101 may obtain the feature information 610 by backprojecting each of the plurality of images 341, 342, 343, and 344 in the virtual three-dimensional space. The electronic device 101 may obtain locations of body parts included in the body 330 based on a three-dimensional space by using the feature information 610 reversely projected in the three-dimensional space. The electronic device 101 may obtain location information (e.g., the location information 510 of FIG. 5) indicating locations of body parts based on the three-dimension or a posture of a body by using the feature information 610.

For example, the electronic device 101 may obtain the feature information 610 by using some of the feature information 620 (e.g., at least one of the feature information 621, the feature information 622, the feature information 623, and/or the feature information 624) obtained from each of the plurality of images 341, 342, 343, and 344. For example, in a case of identifying to temporarily refrain from obtaining data corresponding to a location (e.g., the location 515 of FIG. 5) of a body part (e.g., elbow) included in the third image 343, the electronic device 101 may refrain from using data corresponding to the third image 343 to obtain the location of the body part (e.g., elbow) based on the three-dimension. The feature information 610 indicating the location of the body part (e.g., elbow) based on the three-dimension may be obtained using the data corresponding to the location of the body part (e.g., elbow) obtained using other images (e.g., the first image 341, the second image 342, or the fourth image 344) different from the third image 343. It is not limited thereto.

The electronic device 101 according to an embodiment may obtain the feature information 620 based on the two-dimension using the plurality of images 341, 342, 343, and 344 based on the two-dimension. The electronic device 101 may obtain the feature information 610 based on the three-dimension based on obtaining the feature information 620 based on the two-dimension. The electronic device 101 may obtain location information indicating a posture of a body (e.g., the body 330 of FIG. 3) captured by the external electronic devices 150 and/or locations of body parts included in the body based on obtaining the feature information 610 based on the three-dimension.

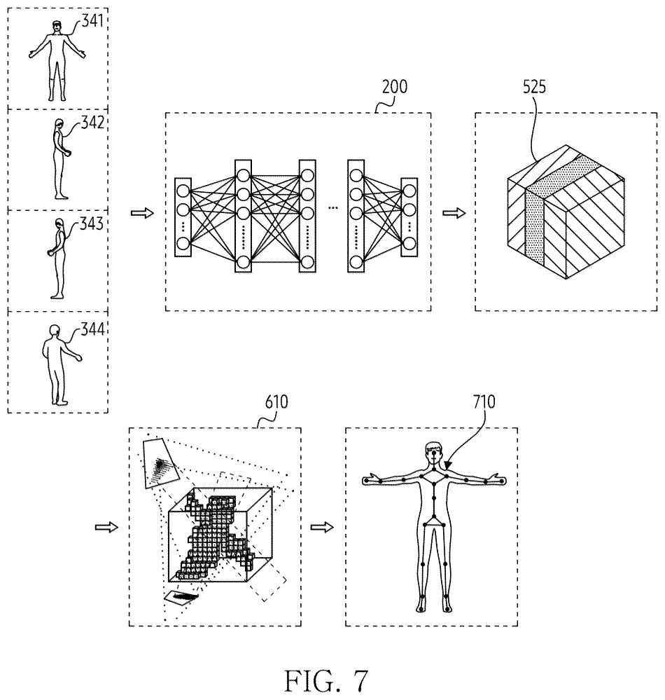

FIG. 7 illustrates an example of an operation in which an electronic device identifies a location of a body part based on a three-dimension from an image according to an embodiment. FIG. 8 illustrates an exemplary flowchart indicating an operation of an electronic device according to an embodiment. An electronic device 101 of FIG. 7 may include the electronic device 101 of FIGS. 1 to 6. At least one of operations of FIG. 8 may be performed by the electronic device 101 of FIG. 1 or the processor 120 of FIG. 1. Each of the operations of FIG. 8 may be performed sequentially, but is not necessarily performed sequentially. For example, an order of each of the operations may be changed, and at least two operations may be performed in parallel.

Referring to FIG. 7, the electronic device 101 according to an embodiment may input a plurality of images 341, 342, 343, and 344 obtained from a plurality of external electronic devices (e.g., the external electronic devices 150 of FIG. 1) positioned at different locations, respectively, to a neural network 200. For example, the electronic device 101 may obtain heat map information based on a probability distribution indicating locations of body parts included in the plurality of images 341, 342, 343, and 344 from each of the plurality of images 341, 342, 343, and 344. The electronic device 101 may temporarily refrain from obtaining data indicating a location (e.g., the location 515 of FIG. 5) of a first body part (e.g., elbow) included in each of the plurality of images based on visibility values for each of the body parts by using the heat map information.

Referring to FIG. 8, in an operation 810, the electronic device according to an embodiment may input at least one of a plurality of images obtained at different locations into a neural network. The plurality of images may correspond to the plurality of images 341, 342, 343, and 344 of FIG. 3.

In an operation 820, the electronic device according to an embodiment may obtain the heat map information indicating a probability that the locations of the body parts included in the plurality of images exist. The electronic device may input at least one of the plurality of images to a backbone network included in the neural network. From the at least one input to the backbone network, the electronic device may obtain feature information (e.g., the feature information 520 of FIG. 5) indicating a type of body parts captured in the at least one or locations of the body parts. The electronic device may obtain the feature information by using the heat map information.

Referring to FIG. 7, the electronic device 101 according to an embodiment may set a weight corresponding to the first body part in order to temporarily refrain from obtaining the data indicating the location of the first body part. The electronic device 101 may change a probability that each of the locations of the body parts obtained from the heat map information (e.g., the heat map information 510 of FIG. 5) exists based on setting the weight. The electronic device 101 may obtain first information (e.g., the feature information 525 of FIG. 5) based on changing the probability. The electronic device 101 may correct the locations of each of the body parts obtained by the heat map information by changing data respectively corresponding to locations of each of the body parts using the weight.

Referring to FIG. 8, in an operation 830, the electronic device according to an embodiment may at least temporarily refrain from obtaining the data indicating the location of the first body part included in each of the plurality of images using the visibility values from the heat map information. The electronic device may identify the first body part included in an image (e.g., the third image 343 of FIG. 3) among the plurality of images. The electronic device may identify visibility for the first body part based on identifying the first body part occluded by a second body part distinguished from the first body part among the body parts. The electronic device may set a weight for the first body part to be relatively low by identifying that the first body part is covered by the second body part. The electronic device may at least temporarily refrain from obtaining the data indicating the location of the first body part based on the weight set relatively low.

In an operation 840, the electronic device according to an embodiment may obtain the first information (e.g., the feature information 525 of FIG. 5) in which the probability that the locations of the body parts included in the heatmap information exist is changed based on at least temporarily refraining from obtaining the data indicating the location of the first body part. For example, the electronic device may use other location data of the first body part included in another image to identify the location of the first body part, based on temporarily refraining from obtaining the location data of the first body part included in the image (e.g., the third image 343 of FIG. 3). The electronic device may reduce a loss rate of data to be processed by the electronic device by using the other data to identify the location of the first body part. Temporary refraining from obtaining the data may include an operation in which the electronic device reduces a value of the data based on the weight.

Referring to FIG. 7, the electronic device 101 may identify feature information 610 based on a three-dimension based on obtaining the feature information 525 from each of the plurality of images 341, 342, 343, and 344. The electronic device 101 may obtain the feature information 610 based on the three-dimension by backprojecting each of the plurality of images 341, 342, 343, and 344. The electronic device 101 may obtain location information 710 indicating locations of each of body parts included in a body (e.g., the body 330 of FIG. 3) captured from the external electronic devices 150 based on obtaining the feature information 610 based on the three-dimension. The electronic device 101 may relatively improve reliability for the location information 710 by temporarily refraining from obtaining data indicating a location of a body part based on visibility. The location information 710 may correspond to the location information 510 of FIG. 5. The location information 710 may include information on each of locations of each of body parts positioned in a three-dimensional virtual space.

Referring to FIG. 8, in an operation 850, the electronic device according to an embodiment may obtain second information (e.g., the location information 710) indicating locations of body parts at a viewpoint at which the plurality of images are obtained based on the first information. The second information may include information on a posture and/or locations of the body parts based on the three-dimension.

The second information may be used to track positions of body parts in the virtual three-dimensional space.

The electronic device 101 according to an embodiment may identify body parts of a body (e.g., the body 330 of FIG. 3) included in each of the plurality of images 341, 342, 343, and 344 captured at substantially the same timing by using the plurality of images 341, 342, 343, and 344 based on a plurality of viewpoints. The electronic device 101 may further improve speed, accuracy, and/or data usability for identifying locations of each of body parts other than identifying each of the locations of the body parts using a plurality of frame images (e.g., video) captured based on one viewpoint, by determining whether to obtain data indicating a location based on visibility values for each of the body parts to identify the locations of each of the body parts using the plurality of images 341, 342, 343, and 344.

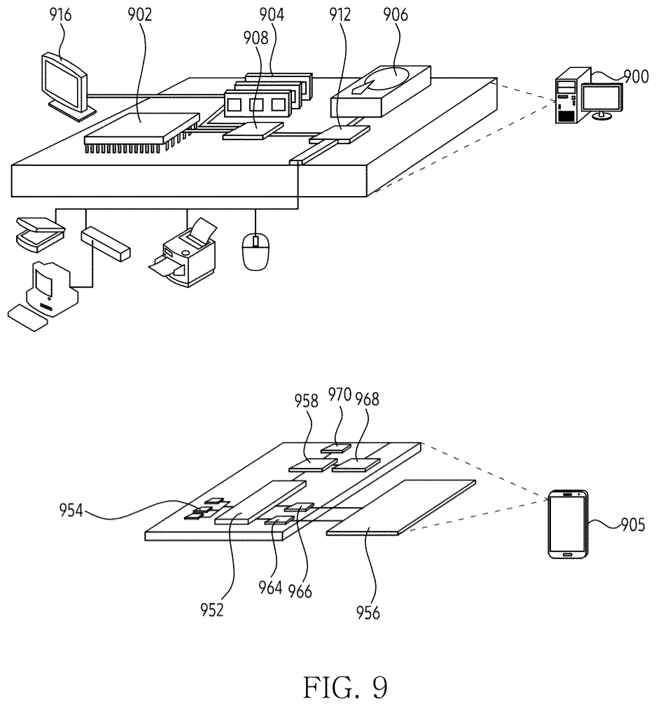

FIG. 9 is a simplified block diagram illustrating a functional configuration of an electronic device according to an embodiment.

Referring to FIG. 9, an electronic device 900 according to an embodiment may include a processor 902, memory 904, a storage device 906, a high-speed controller 908 (e.g., a northbridge, a main controller hub (MCH)), a low-speed controller 912 (e.g., a southbridge, an input/output (I/O) controller hub (ICH)). In the electronic device 900, each of the processor 902, the memory 904, the storage device 906, the high-speed controller 908, and the low-speed controller 912 may be interconnected using various buses. For example, the processor 902 may process instructions for execution in the electronic device 900 to display graphic information on a graphical user interface (GUI) on an external input/output device such as a display 916 connected to the high-speed controller 908. The instructions may be included in the memory 904 or the storage device 906. The instructions, when executed by the processor 902, may cause the electronic device 900 to perform one or more operations described above and/or one or more operations described below. According to embodiments, the processor 902 may be configured with a plurality of processors including a communication processor and a graphical processing unit (GPU).

For example, the memory 904 may store information in the electronic device 900. For example, the memory 904 may be a volatile memory unit or units. For another example, the memory 904 may be a nonvolatile memory unit or units. For an additional example, the memory 904 may be another form of computer-readable medium, such as a magnetic or optical disk.

For example, the storage device 906 may provide a mass storage space to the electronic device 900. For example, the storage device 906 may be a computer-readable medium, such as a hard disk device, an optical disk device, flash memory, a solid-state memory device, or an array of devices in a storage area network (SAN).

For example, the high-speed controller 908 may manage bandwidth-intensive operations for the electronic device 900, whereas the low-speed controller 912 may manage low-bandwidth intensive operations for the electronic device 900. For example, the high-speed controller 908 may be coupled to the memory 904 and coupled to the display 916 through the GPU or an accelerator, whereas the low-speed controller 912 may be coupled to the storage device 906 and coupled to various communication ports (e.g., universal serial bus (USB), Bluetooth, Ethernet, and wireless Ethernet) for communicating with an external electronic device (e.g., a keyboard, a transducer, a scanner, or a network device (e.g., a switch or a router)).

According to an embodiment, an electronic device 950 may be another example of the electronic device 900. The electronic device 950 may include a processor 952, memory 954, an input/output device such as a display 956 (e.g., an organic light emitting diode (OLED) display or another display), a communication interface 958, and a transceiver 962. Each of the processor 952, the memory 954, the input/output device, the communication interface 958, and the transceiver 962 may be interconnected using various buses.

For example, the processor 952 may process instructions included in the memory 954 to display graphic information on a GUI on the input/output device. The instructions, when executed by the processor 952, may cause the electronic device 950 to perform one or more operations described above and/or one or more operations described below. For example, the processor 952 may interact with a user through a display interface 964 and a control interface 966 coupled with the display 956. For example, the display interface 964 may include circuitry for driving the display 956 to provide visual information to the user, and the control interface 966 may include circuitry for receiving commands received from the user and converting the commands to provide them to the processor 952. According to embodiments, the processor 952 may be implemented as a chipset of chips including analog and digital processors.

For example, the memory 954 may store information in the electronic device 950. For example, the memory 954 may include at least one of one or more volatile memory units, one or more nonvolatile memory units, or a computer-readable medium.

For example, the communication interface 958 may perform wireless communication between the electronic device 950 and an external electronic device through various communication techniques such as a cellular communication technique, a Wi-Fi communication technique, an NFC technique, or a Bluetooth communication technique based on a link with the processor 952. For example, the communication interface 958 may be coupled with the transceiver 968 to perform the wireless communication. For example, the communication interface 958 may be further coupled with a global navigation satellite system (GNSS) receiving module 970 to obtain location information of the electronic device 950.

According to an embodiment, the electronic device 900 (and/or the electronic device 950) may obtain location information for indicating a shape of a body of a subject based on obtaining an image from a plurality of cameras. For example, the electronic device 900 (and/or the electronic device 950) may obtain the location information for indicating location of the body in a virtual three-dimensional space from a plurality of images that shoot the body in different viewpoints. The electronic device 900 (and/or the electronic device 950) may utilize a pre-trained neural network to obtain the location information. For example, the electronic device 900 (and/or the electronic device 950) may infer a location of each of body parts based on a relationship with respect to the location of each of the body parts included in an image using a neural network based on a self-attention structure. The electronic device 900 (and/or the electronic device 950) may identify visibility for each of the body parts included in the image to infer the location. The electronic device 900 (and/or the electronic device 950) may update probability information indicating locations for each of the body parts by changing data indicating the locations for each of the body parts based on the visibility values. The electronic device 900 (and/or the electronic device 950) may improve accuracy of the location information on the locations by updating the probability information. The electronic device 900 (and/or the electronic device 950) may be referred to the electronic device 101 of FIGS. 1 to 8.

According to an embodiment, an electronic device may comprise memory, and a processor. The processor may be configured to obtain, by inputting to a neural network at least one of a plurality of images obtained at different locations, first information indicating locations of body parts included in the plurality of images. The processor may be configured to obtain, based on the first information, second information indicating locations of the body parts at moments when the plurality of images were obtained. The first information obtained by the neural network may include data, with respect to a first image among the plurality of images, indicating locations in the first image of different portions of the body parts based on visibility values of the portions.

For example, the processor may configured to decrease, in the first image, a value of data indicating a location of a first body part among the body parts using the visibility values.

For example, the processor may configured to obtain, from the plurality of images, third information indicating a probability that the locations of the body parts exist. The processor may configured to set, based on the visibility values with respect to each of the body parts using the third information, weights respectively corresponding to the locations of the body parts. The processor may configured to obtain, using the weights, the data indicating the locations.

For example, the processor may configured to decrease, based on identifying the first body part occluded by a second body part among the plurality of body parts in the first image based on the visibility values, a value of the data indicating the location of the first body part.

For example, the processor may configured to decrease, based on changing a weight corresponding to the location of the occluded first body part, a value of the data indicating the location of the first body part.

For example, the processor may configured to identify, using a second image different from the first image, the first body part occluded by the second body part.

For example, the processor may configured to obtain, by backprojecting the first information indicated in a virtual two-dimensional space onto a virtual three-dimensional space, the second information based on a three-dimension indicating a posture of the body parts in a virtual three-dimensional space.

For example, each of the plurality of images may be obtained from each of the plurality of cameras directed toward the body from each of the different locations.

For example, the neural network may include an operation to obtain weights respectively corresponding to the body parts based on the visibility values.

According to an embodiment, in a method performed by an electronic device, the method may comprise obtaining, by inputting to a neural network at least one of a plurality of images obtained at different locations, first information indicating locations of body parts included in the plurality of images. The method may comprise obtaining, based on the first information, second information indicating locations of the body parts at moments when the plurality of images were obtained. The first information obtained by the neural network may include data, with respect to a first image among the plurality of images, indicating locations in the first image of different portions of the body parts based on visibility values of the portions.

For example, the obtaining the first information may comprise decreasing, in the first image, a value of data indicating a location of a first body part among the body parts using the visibility values.

For example, the obtaining the first information may comprise obtaining, from the plurality of images, third information indicating a probability that the locations of the body parts exist. The obtaining the first information may comprise setting, based on the visibility values with respect to each of the body parts using the third information, weights respectively corresponding to the locations of the body parts. The obtaining the first information may comprise obtaining, using the weights, the data indicating the locations.

For example, the obtaining the first information may comprise decreasing, based on identifying the first body part occluded by a second body part among the plurality of body parts in the first image based on the visibility values, a value of the data indicating the location of the first body part.

For example, the decreasing the value of the data may comprise decreasing, based on changing a weight corresponding to the location of the occluded first body part, a value of the data indicating the location of the first body part.

For example, the decreasing the value of the data may comprise identifying, using a second image different from the first image, the first body part occluded by the second body part.

For example, the obtaining the second information may comprise obtaining, by backprojecting the first information indicated in a virtual two-dimensional space onto a virtual three-dimensional space, the second information based on a three-dimension indicating a posture of the body parts in a virtual three-dimensional space.

For example, each of the plurality of images may be obtained from each of the plurality of cameras directed toward the body from each of the different locations.

For example, the neural network may include an operation to obtain weights respectively corresponding to the body parts based on the visibility values.

According to an embodiment, in a computer readable storage medium storing one or more programs, the one or more programs may be configured to, when executed by a processor of an electronic device, obtain, by inputting to a neural network at least one of a plurality of images obtained at different locations, first information indicating locations of body parts included in the plurality of images. The one or more programs may include instructions, when executed by the processor of the electronic device, causing the electronic device to obtain, based on the first information, second information indicating locations of the body parts at moments when the plurality of images were obtained. The first information obtained by the neural network may include data, with respect to a first image among the plurality of images, indicating locations in the first image of different portions of the body part based on visibility values of the portions.

For example, the one or more programs may be configured to include instructions, when executed by the processor of the electronic device, causing the electronic device to decrease, in the first image, a value of data indicating a location of a first body part among the body parts using the visibility values.

The device described above may be implemented as a hardware component, a software component, and/or a combination of a hardware component and a software component. For example, the devices and components described in the embodiments may be implemented by using one or more general purpose computers or purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. The processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. Another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. The medium may continuously store a program executable by the computer or may temporarily store the program for execution or download. The medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and DVD, magneto-optical medium, such as a floptical disk, and those configured to store program instructions, including ROM, RAM, flash memory, and the like. Examples of other media may include recording media or storage media managed by app stores that distribute applications, sites that supply or distribute various software, servers, and the like.

Although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

Other implementations, other embodiments, and those equivalent to the scope of the claims are in the scope of the claims described later.

What is claimed is:

1. An electronic device comprising:
memory storing instructions; and
one or more processors,
wherein the instructions, when executed by the one or more processors, cause the electronic device to:
input, into a neural network, at least one image, from among a plurality of images that are obtained from different viewpoints, to obtain first information indicating locations of a plurality of body parts of a subject included in the plurality of images, wherein the first information comprises first location data indicating a first plurality of locations of a plurality of portions of the plurality of body parts within a first image from among the plurality of images, and wherein the first plurality of locations are determined based on a first plurality of visibility values of the plurality of portions in the first image;
obtain, based on the first information, second information indicating a second plurality of locations of the plurality of body parts at moments when the plurality of images were obtained; and
track positions of the plurality of body parts in a virtual three-dimensional space based on the second information.

2. The electronic device of claim 1, wherein the instructions, when executed by the one or more processors, cause the electronic device to decrease a first value of the first location data based on a first visibility value of the first body part in the first image.

3. The electronic device of claim 2, wherein the instructions, when executed by the one or more processors, cause the electronic device to:
obtain, from the plurality of images, third information indicating a plurality of probabilities corresponding to a third plurality of locations, wherein the plurality of probabilities indicate probabilities as to whether one or more body parts, from among the plurality of body parts, are present at locations from among the third plurality of locations;
determine, based on the third information, a second plurality of visibility values corresponding to the one or more body parts;
set a plurality of weights corresponding to the third plurality of locations based on the second plurality of visibility values; and
update the first location data based on the plurality of weights.

4. The electronic device of claim 2, wherein the instructions, when executed by the one or more processors, cause the electronic device to decrease the first value based on identifying, in the first image, that the first body part is occluded by a second body part from among the plurality of body parts.

5. The electronic device of claim 4, wherein the instructions, when executed by the one or more processors, cause the electronic device to decrease the first value based on a change to a first weight corresponding to a first location of the first body part that is occluded by the second body part.

6. The electronic device of claim 4, wherein the instructions, when executed by the one or more processors, cause the electronic device to,
identify the first body part is occluded by the second body part based on a second image from among the plurality of images.

7. The electronic device of claim 2, wherein the first information is represented in a virtual two-dimensional space, the second information is represented in the virtual three-dimensional space, and a posture of the plurality of body parts is represented in the virtual three-dimensional space, and
wherein the instructions, when executed by the one or more processors, cause the electronic device to obtain the second information by backprojecting the first information from the virtual two-dimensional space into the virtual three-dimensional space.

8. The electronic device of claim 1, wherein the plurality of images are obtained from a plurality of external electronic devices directed toward the subject from different locations.

9. The electronic device of claim 1, wherein the instructions, when executed by the one or more processors, cause the electronic device to obtain a plurality of weights corresponding to the plurality of body parts, via the neural network, based on a second plurality of visibility values.

10. A method performed by an electronic device, comprising:
inputting, into a neural network, at least one image, from among a plurality of images that are obtained from different viewpoints, to obtain first information indicating locations of a plurality of body parts included in the plurality of images, wherein the first information comprises first location data indicating a first plurality of locations of a plurality of portions of the plurality of body parts within a first image from among the plurality of images, and wherein the first plurality of locations are determined based on a first plurality of visibility values of the plurality of portions in the first image;
obtaining, based on the first information, second information indicating a second plurality of locations of the plurality of body parts at moments when the plurality of images were obtained; and
tracking positions of the plurality of body parts in a virtual three-dimensional space based on the second information.

11. The method of claim 10, wherein the method further comprises decreasing a first value of the first location data based on a first visibility value of a first body part in the first image.

12. The method of claim 11, wherein the obtaining the first information comprises:
obtaining, from the plurality of images, third information indicating a plurality of probabilities corresponding to a third plurality of locations, wherein the plurality of probabilities indicate probabilities as to whether one or more body parts, from among the plurality of body parts, are present at locations from among the third plurality of locations;
determine, based on the third information, a second plurality of visibility values corresponding to the one or more body parts;
setting a plurality of weights corresponding to the third plurality of locations based on the second plurality of visibility values; and
update the first location data based on the plurality of weights.

13. The method of claim 11, wherein the decreasing the first value further comprises decreasing the first value based on identifying, in the first image, that the first body part occluded by a second body part from among the plurality of body parts.

14. The method of claim 13, wherein the decreasing the first value comprises decreasing the first value based on a change to a first weight corresponding to a first location of the first body part that is occluded by the second body part.

15. The method of claim 13, wherein the decreasing the first value comprises identifying that the first body part is occluded by the second body part based on a second image from among the plurality of images.

16. The method of claim 11, wherein the first information is represented in a virtual two-dimensional space, the second information is represented in the virtual three-dimensional space, and a posture of the plurality of body parts is represented in the virtual three-dimensional space, and
wherein the obtaining the second information comprises obtaining the second information by backprojecting the first information from the virtual two-dimensional space into the virtual three-dimensional space.

17. The method of claim 10, wherein the plurality of images are obtained from a plurality of external electronic devices directed toward the subject from different locations.

18. The method of claim 10, further comprises obtaining a plurality of weights corresponding to the plurality of body parts, via the neural network, based on a second plurality of visibility values.

19. A non-transitory computer readable storage medium having instructions recorded thereon, that, when executed by one or more processors, cause the one or more processors to:
input into a neural network, at least one image from among a plurality of images that are obtained from different viewpoints, to obtain first information indicating locations of a plurality of body parts of a subject included in the plurality of images, wherein the first information comprises first location data indicating a first plurality of locations of a plurality of portions of the plurality of body parts within a first image from among the plurality of images, and wherein the first plurality of locations are determined based on a first plurality of visibility values of the plurality of portions in the first image; and
obtain, based on the first information, second information indicating a second plurality of locations of the plurality of body parts at moments when the plurality of images were obtained; and
track positions of the plurality of body parts in a virtual three-dimensional space based on the second information.

20. The non-transitory computer readable storage medium of claim 19, wherein instructions, when executed by the one or more processors, cause the one or more processors to decrease a first value of the first location data based on a first visibility value of the first body part in the first image.
